(19) United States
(12) Patent Application Publication
(10) Pub. No.: US 2015/0200824 A1
(43) Pub. Date: Jul. 16, 2015

(54) OVERALL SYSTEM HEALTH MONITORING OF AN ONLINE SERVICE

(71) Applicant: MICROSOFT CORPORATION, Redmond, WA (US)

(72) Inventors: Art Sadovsky, Redmond, WA (US); Venkataramanan Narayanan, Redmond, WA (US); Vivek Sharma, Redmond, WA (US); Chenchen Zhu, Redmond, WA (US); Hailei Chen, Redmond, WA (US); Smita Ojha, Redmond, WA (US); Ashish Premaraj, Issaquah, WA (US)

(73) Assignee: MICROSOFT CORPORATION, Redmond, WA (US)

(21) Appl. No.: 14/152,802

(22) Filed: Jan. 10, 2014

(51) Int. Cl. H04L 12/26

(52) U.S. Cl. CPC H04L 43/0817; H04L 43/16

(57) ABSTRACT

The overall health of an online service is determined using health information that is obtained from the individual components of the online service. For example, an overall health score for the online service may be determined by computing an average score using health scores that are received from the different components. The amount an individual component's health score affects the overall health score of the online service is configurable. In some cases, a health alert may be sent to the component(s) experiencing the problem as well as sending the health alert to the system level. In other cases, the alerts to the component level may be suppressed and the system level administrator receives the alert. A health alert may show information such as the overall health score, the health score for each individual component, a description of any detected problems, a graphical health map of the system, and the like.

### BACKGROUND

Users can become very frustrated when attempting to interact with an online service that is experiencing problems. For example, a user may become frustrated when they cannot log into the service or when a requested operation takes a long time to perform. In order to help detect problems, many online services perform different methods to assist in determining when a component of the online service is not operating as expected. For example, the online service may perform monitoring to detect issues relating to logging into the online service, interacting with the service, and the like. Generally, when a problem is detected with the online service, a notification of the problem is delivered to a system administrator that manages the component that is experiencing the problem. For example, when there is a problem detected with a login component of the online service, the system administrator for the login component is notified of the problem. In some cases, however, the problem may affect more than one component.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The overall system health of an online service is determined using health information that is obtained from the different individual components that perform operations for the online service. The overall system health represents the health of the overall service at the system level instead of the health of the individual components of the service. An overall system health score for the online service is computed using aggregated health information that is obtained from each of the components. For example, health scores that are received from each of the different components may be combined and averaged to determine the overall system health score for the online service. The amount an individual component's health score affects the overall system health score of the online service is configurable. For example, some components of the online service may be set to a higher priority level such that the components health score having a higher priority affects the overall system health score more as compared to the health scores from components having a lower priority. Health scores may be determined for different subsystems of the overall system. For example, there may be a global system health score that is determined for the entire worldwide service, as well as other system health scores that are determined based on a location of a portion of the components (e.g., country, state . . . ) or based on a particular subset of users of the service.

Health alerts relating to the overall system health are received by a user (e.g., an administrator) at the system level. For example, a health alert may be received at the system level when the overall system health score drops below a predetermined health threshold. A health alert may also be received at the system level when the overall system health score changes quickly between successive determinations of the overall system health score or when the overall health score remains depressed for some period of time. In some cases, a health alert may be sent to the component(s) experiencing the problem as well as sending the health alert to the system level. In other cases, alerts sent to a user at the component level may be suppressed and a user at the system level receives the alert. The alerts may include different types of information. For example, the alert may show information such as the overall health score, the health score for each individual component, a description of any detected problems, a graphical representation of the health of the system, and the like.

### BRIEF DESCRIPTION OF THE DRAWINGS

FIG. 1 shows an overview of a system for system level health monitoring for an online service;

FIG. 2 shows a more detailed system for system level health monitoring for an online service;

FIG. 3 shows example displays illustrating example Graphical User Interfaces (GUIs) for displaying health information for an online service;

FIG. 4 shows example Graphical User Interfaces (GUIs) for viewing and configuring preferences that are associated with system level health monitoring or an online service;

FIG. 5 illustrates a process for determining the system level health for an online service;

FIG. 6 illustrates a process for configuring preferences relating to system level health monitoring of an online service;

FIG. 7 illustrates an exemplary online system that includes system level health monitoring; and

FIGS. 8, 9A, 9B and 10 and the associated descriptions provide a discussion of a variety of operating environments in which embodiments of the invention may be practiced.

### DETAILED DESCRIPTION

The overall system health of an online service is determined using health information that is obtained from the different individual components of the online service. For example, an online service that is used for electronic messaging may include different components that a user may access to receive or send electronic messages. The components of the online service used for electronic messaging may include a web component that is used by a user to access electronic message services through a web page, a synchronization component that is used to synchronize messages with one or more of the user's computing devices, a server component that is used by the user to access messages from an installed messaging application on the user's computing device, and the like. A health problem in any of these components affects the overall system health of the online service. For example, a health problem that is initially detected in the synchronization component may indicate a health problem for the entire online service and/or one or more of the other components of the online service. Instead of waiting for an administrator at the synchronization component level to possibly escalate the detected health problem to the system level, an administrator at the system level automatically receives a health alert that includes an overall system health score that represents the overall system health of the online service. In this way, a detected problem that affects the overall system health of the service may possibly be handled more quickly as compared to waiting for a problem to be escalated.

Referring now to the drawings, in which like numerals represent like elements, various embodiment will be described.

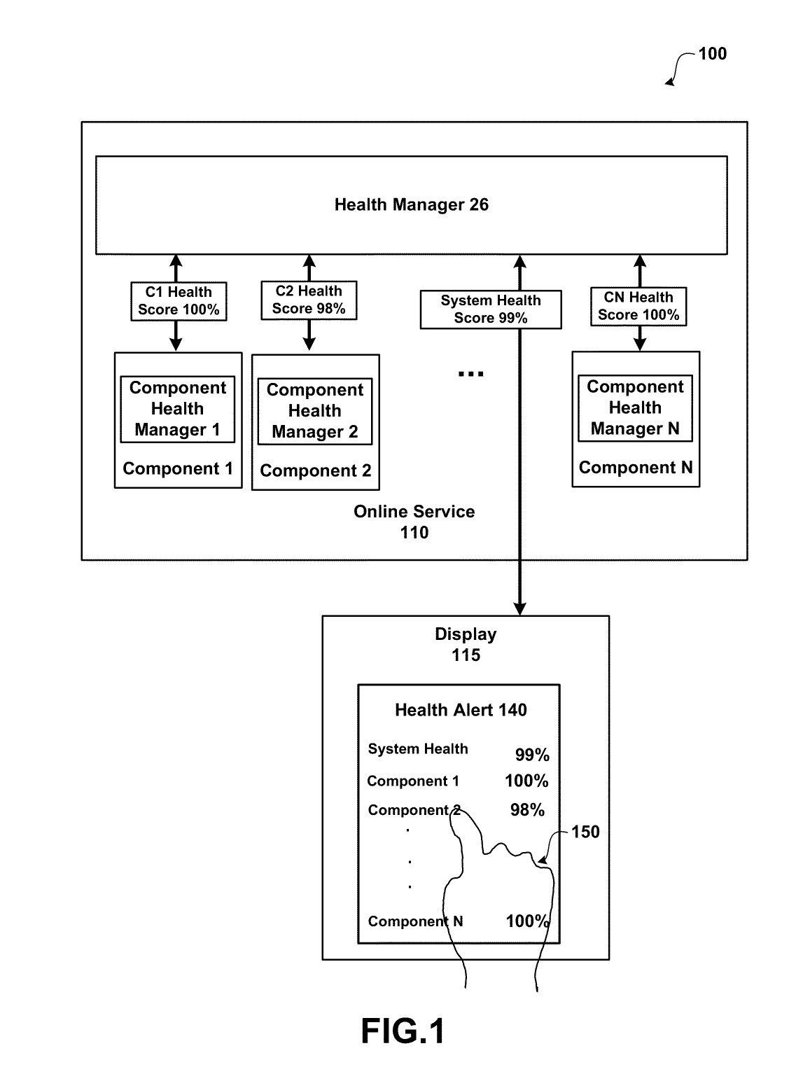

FIG. 1 shows an overview of a system for system level health monitoring for an online service. As illustrated, system 100 includes online service 110, health manager 26, components 1-N, component health-managers 1-N and display 115.

As discussed, instead of waiting for an administrator at a component level to escalate a health problem to the system level, health manager 26 alerts an administrator, or some other user, at the system level in response to a detected health problem for the online service.

Generally, health manager 26 determines an overall system health score of online service 110 using the health information that is obtained from each of the components (e.g., components 1-N). According to an embodiment, a component health manager that is associated with each component determines a health score for the component. Many methods may be used to determine the overall system health score. For example, health scores that are received from each of the different components of the online service may be aggregated and then an average score may be computed to determine an overall system health score for the online service.

According to an embodiment, the amount an individual component's health score affects the overall health score of the online service is configurable. For example, a priority of one or more of the components of the online service may be set to a higher level as compared to another component. In this way, the overall system health score is more affected by the health score of components having a higher priority as compared to lower priority components.

After determining the overall health score, health manager 26 sends a health alert, such as health alert 140, to one or more users (e.g., an administrator or a customer of the service) that includes health information for the online service. Instead of a user at the system level having to wait for a health problem to be escalated from a component level administrator, a health alert is received by a user at the system level from health manager 26 when a health problem is detected.

The health alert may be sent in response to different conditions. According to an embodiment, a health alert, such as health alert 140, is delivered when the overall health score drops below a predetermined health threshold (e.g., 99.5%, 99%, 95%, 80% . . . ). According to another embodiment, a health alert may be sent before the overall system health score drops below the predetermined health threshold. For example, health alert 140 may be sent when the overall system health score or a component's health score changes faster than a predetermined rate. A health alert may also be sent when the overall health score remains between 100% and the predetermined health threshold for some period of time. For example, a health alert may be sent when the overall system health score remains at 98% for six consecutive health readings even though the predetermined level for detecting a health problem for the service is set to 95%. In some cases, a health alert may be sent to the component(s) experiencing the problem as well as sending the health alert to the system level. In other cases, the health alerts that would be sent to the component level may be suppressed and the system level administrator receives the alert.

In the current example, health alert 140 shows that the overall system health is 99%, component 1 has a health score of 100%, component 2 has a health score of 98%, and component N has a health score of 100%. Health alerts may include other or different types of information. For example, the health alert may show more detailed information (e.g., in response to user 150 selecting an item in the health alert) relating to the overall health score or the health scores for each individual component, a description of any detected problems, a graphical representation of the health of the system, and the like (See FIGURES and related discussion below).

Online service 110 may be a cloud based and/or enterprise based service that may be configured to provide services, such as productivity services (e.g., electronic messaging, collaboration, spreadsheets, documents, presentations, charts, and the like). More details regarding determining the health of an online service are provided below.

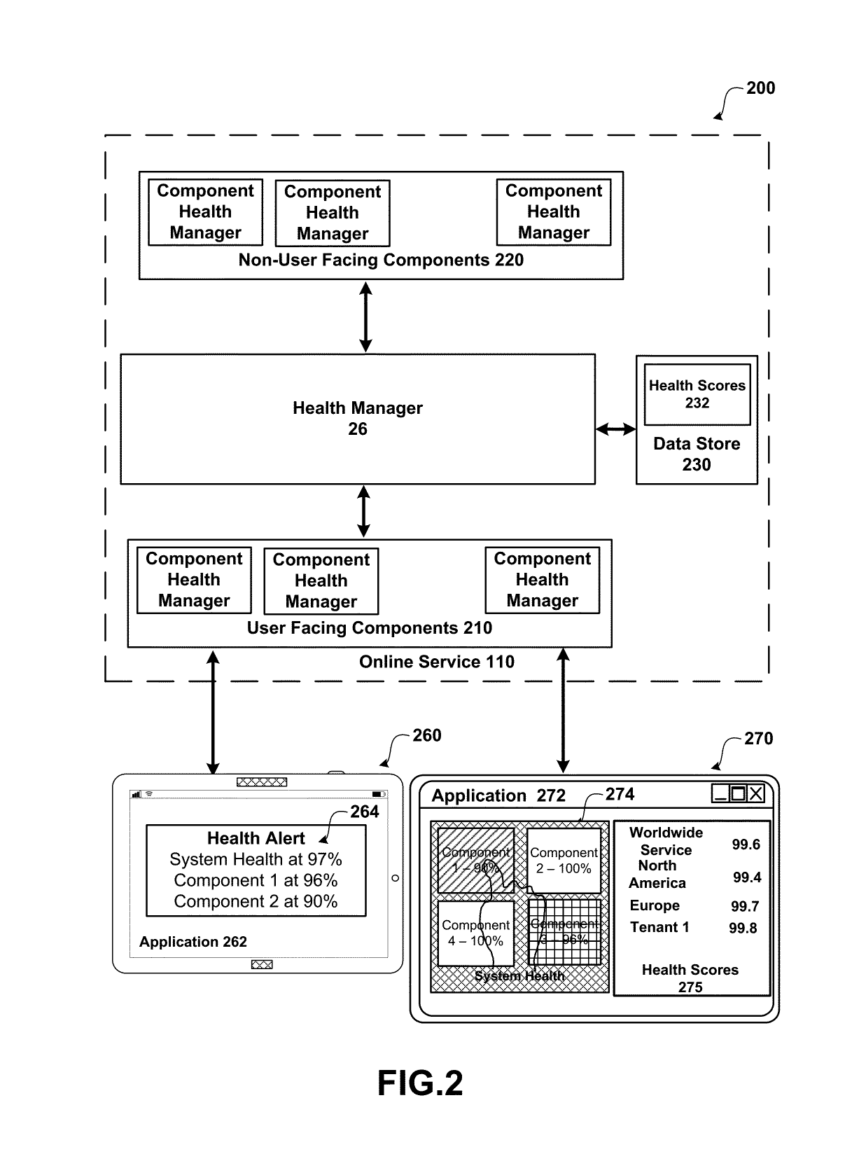

FIG. 2 shows a more detailed system 200 for system level health monitoring for an online service.

As illustrated, system 200 includes application 262, application 272, tablet computing device 260, computing device 270 and online service 110 that includes health manager 26, user facing components 210, non-user facing components 220 and data store 230 that includes health scores 232.

As discussed, health manager 26 is configured to determine the overall health of online service 110 using health information that is obtained from different components of the online service. The components may include user facing components 210 that are interacted with directly by the user and non-user facing components 220 that perform operations for the online service without directly interfacing with the user. For example, a user facing component of online service 110 may be a component that displays a web page that a user interacts with to access functionality of the service (e.g. accessing a document, sending a message . . . ). Generally, a user facing component is a component that is used by a user to initiate a connection with the online service and to receive or send information to the online service. An example of a non-user facing component is a processing component that stores information for the online service. Generally, a non-user facing component is a component that is used by the online service to perform operations to support the operations of the online service but does not receive direct interaction from a user.

Health manager 26 periodically determines an overall system health score of the online service using the health information that is obtained from each of the components. For example, health manager 26 accesses a health score at predetermined times (e.g., two minutes, three minutes, five minutes, ten minutes, hourly, . . . ) that is received from each of the user facing components 210 and each of the non-user facing components 220.

The health scores may be received directly by health manager 26 or accessed from a data store, such as data store 230. According to an embodiment, health manager 26 accesses the health scores from health scores 232 that is stored in data store 230. All or a portion of the components of the online service may be used in determining the overall system health score for the online service. For example, a component may also be excluded from the determination of the overall system health score. According to an embodiment, the overall health score for the online service is the average of the health scores that are received from each of the components. As discussed, the amount an individual component's health score affects the overall health score of the online service is configurable. For example, the health score from some of the components may affect the overall system health score more than other components of the online service.

Health manager 26 is configured to send a health alert (e.g. health alert 264 or health alert 274) in response to different conditions. For example, a health alert may be sent automatically in response to some determined event or manually in response to a request for a health alert. According to an embodiment, a health alert is automatically sent when the overall system health score drops below a predetermined health threshold, when the overall system health score stays at a depressed level for a period of time, or when the overall system health score is quickly changing between determinations of the overall system health. For example, health alert 264 or health alert 274 may be sent when the overall system health score or a component's health score changes faster than a predetermined rate between successive determinations of the health scores.

In some cases, a health alert may be sent to the component(s) experiencing the problem as well as sending the health alert to the system level. In other cases, the alerts to the component level may be suppressed and the system level administrator receives the alert. Health alerts may include different types of information. For example, health alerts may show information such as the overall health score, the health score for each individual component, a description of any detected problems, a graphical representation of the health of the system, and the like.

Health manager 26 may also determine health scores for different subsystems of the overall service. For example, there may be a global system health score that is determined for the entire service, as well as other system health scores that are determined based on a location of a portion of the components (e.g., based on country, state . . . ) or based on a particular subset of users of the service. Health scores 275 shows an example that includes a health score for the worldwide service (99.6), a health score for the components in North America (99.4), a health score for the components in Europe (99.7) as well as a health score relating to the accounts for Tenant 1 (99.8). According to an embodiment, an authorized user may determine the different health scores that are computed by health manager 26 and that are included in a health alert.

As illustrated, health alert 264 that is displayed on tablet computing device 260 displays the overall health of the online service (97%), and the health scores for component 1 (96%) and component 2 (90%). As another example, health alert 274 that is displayed on computing device 270 shows a graphical health map of the health of the online service. As illustrated, the components and the system health are displayed using different formatting depending on the health score that is associated with the component and the overall system health score. In the current example, component 2 and component 4 are shown using one fill pattern, component 1 is shown in a second fill pattern, component 3 is shown in another fill pattern and the overall system health for the online service is shown in yet another fill pattern. The graphical health map is directed at allowing a user receiving the alert to more easily identify and locate the components experiencing a health problem. The graphical health map may also show a location of where health problems are occurring. For example, in an online service that spans a large geographical area, the components may be displayed according to their geographical area such that the system level administrator may readily determine the location of where the health problems are occurring.

Data store 230 is configured to store health information relating to the health of online service 110 in health scores 232. According to an embodiment, health scores 232 stores current health scores and past health scores for the online service. For example, health scores 232 is a table of health information that includes the current overall health and the current health scores from each of the components. According to an embodiment, the table also includes a predetermined number of previous health scores (e.g., one, two, three, five . . . ) determined for the online service. The health scores in health scores 232 is updated when a new health score is received. In this way, health manager 26 may access health scores 232 in order to determine the latest health scores from the components.

Data store 230 may also include configuration information relating to the health monitoring such as a value for the predetermined threshold used in determining when to send an alert, a priority or weighting value for each component, a rate of change value that is used in determining when to send an alert even though the predetermined threshold has not been reached, and the like. According to an embodiment, an authorized user may configure the information that is stored in data store 230.

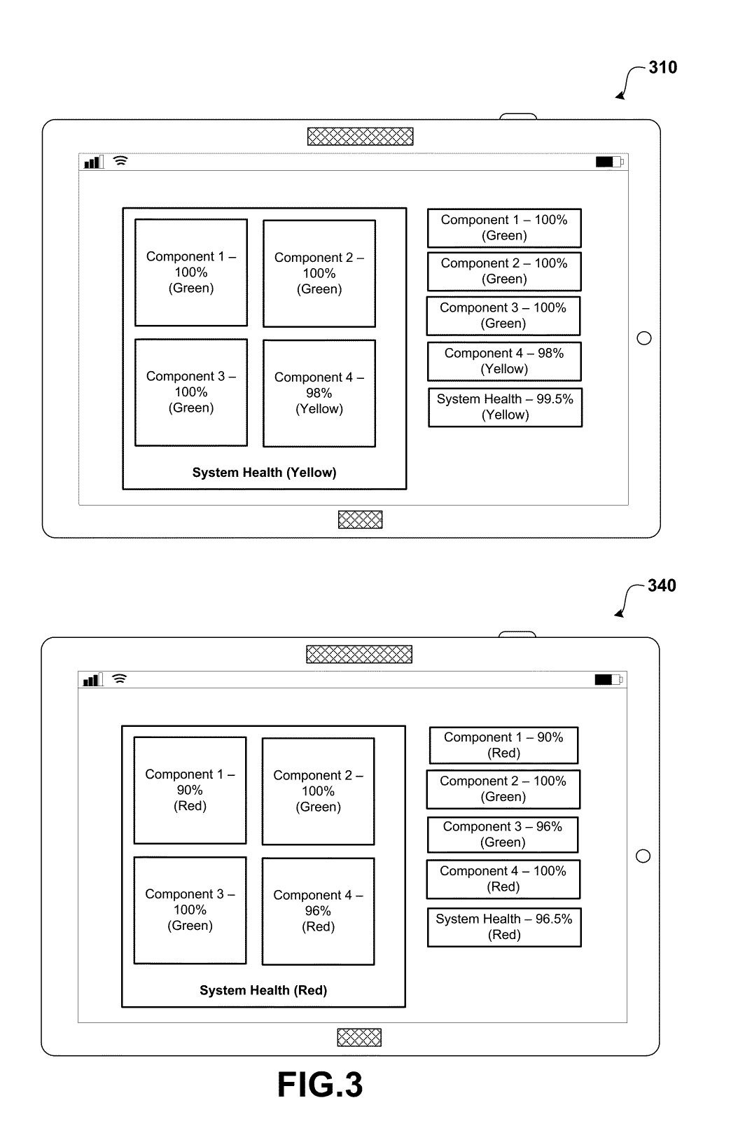

FIG. 3 shows example displays illustrating example Graphical User Interfaces (GUIs) for displaying health information for an online service. The GUIs that are shown in FIG. 3 are for illustrative purposes and are not intended to be limiting.

Display 310 and display 340 show health information for the online service. As illustrated, the health information for a component and the overall system health is shown using a value for the health score (e.g., 90%, 95%, 100% . . . ) along with displaying a graphical object that represents the components and the system. In the current example, the graphical objects that represent the components and the system are formatted such that components having different health scores are visually distinguishable. For example, a graphical object that represents a component is colored: green when operating without health problems (e.g., 100%); yellow when operating below 100% (or some other threshold) but above the health threshold indicating a health problem (e.g., 97% in this example) and red when a health problem is determined to be below the threshold or needs further attention. While three colors are shown, many more colors and shades of colors may be used in coloring the components and the system health. Similarly, other types of formatting may be used to visually distinguish different health scores (e.g., fill patterns, bolding, text formatting . . . ).

Display 310 shows the online service operating in a caution state. According to an embodiment, the online service is in a caution state when the overall system health score is above the health threshold but below an overall system health score of 100% (or some other predetermined value). As can be seen, components 1, 2 and 3 have a health score of 100% and are colored green, whereas component 4 has a health score of 98% and is colored yellow. The graphical object representing the overall system health is colored yellow since the overall system health score for the system (99.5%) is less than 100% but above the health threshold (e.g., 97% or some other value).

Display 340 shows the online service operating in a red state. According to an embodiment, the red state indicates that the overall system health score is below the health threshold (e.g., 97% in this example) indicating a major health problem for the online service. As can be seen, components 1 and 4 have health scores that are below the health threshold and are colored red. Components 2 and 3 have a health score of 100% and are colored green. The graphical representation for the system is colored red since the overall system health score for the system (96.5%) is less than the health threshold of 97%.

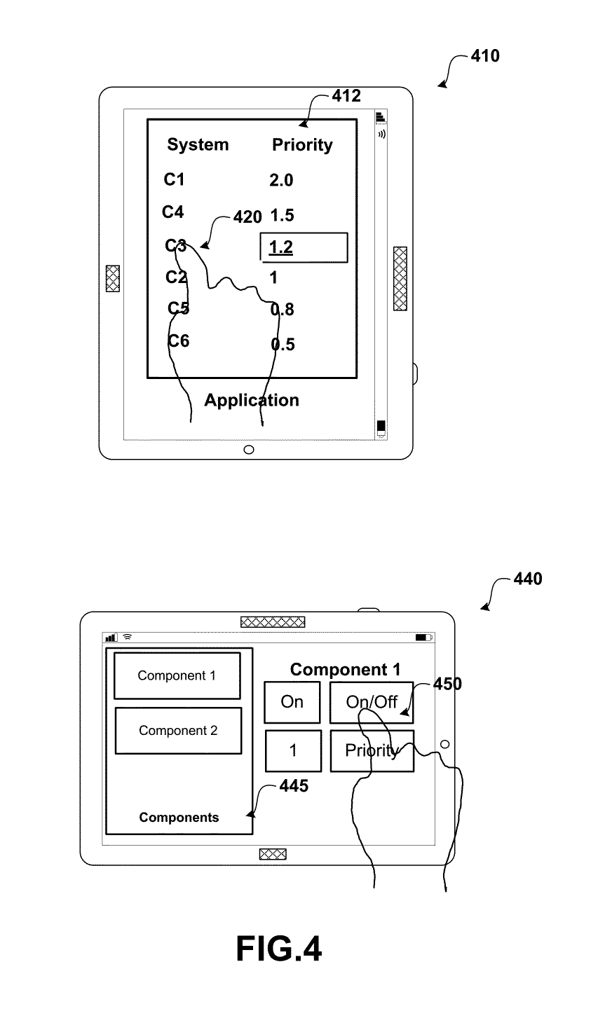

FIG. 4 shows example Graphical User Interfaces (GUIs) for viewing and configuring preferences that are associated with system level health monitoring or an online service. The GUIs shown in FIG. 4 are for illustrative purposes and are not intended to be limiting.

The first GUI that is shown is a priority configuration 410 display that shows an exemplary GUI for selecting and configuring a priority value that is assigned to the different components of the an online service. The priority value affects the weight that the component's health score has on the overall system health score for the online service. For example, when each component has the same priority, the overall system health score is the average value of each of the different health scores that are obtained from the different components. The larger a priority is for a component, the more the component's health score affects the overall health score. The smaller the priority is for a component, the less affect the component's health score has on the overall health score. As illustrated in display 410, user 420 is selecting component C3 from GUI 412 to set the component's priority level. In the current example, the user has set the priority of component C3 to 1.2.

Display 440 shows a user configuring more settings that are associated with a component. As illustrated, display 440 shows a user 450 selecting an on/off option that is used to either include the component's health score in the calculation of the overall system health score or to exclude the component's health score when calculating the overall system health score. A user may also select the “Priority” option to change the component's priority value. Component selector 445 in display 440 shows a list of the different components of the online service that may be configured. According to an embodiment, each component of the online service may be selected and configured.

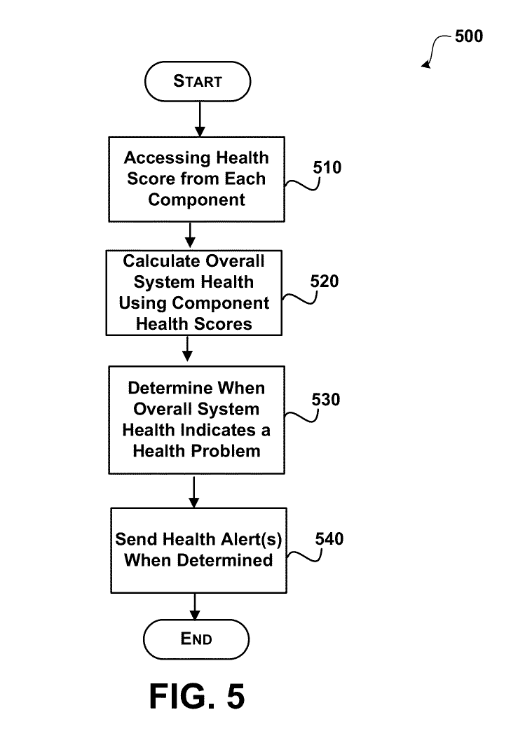

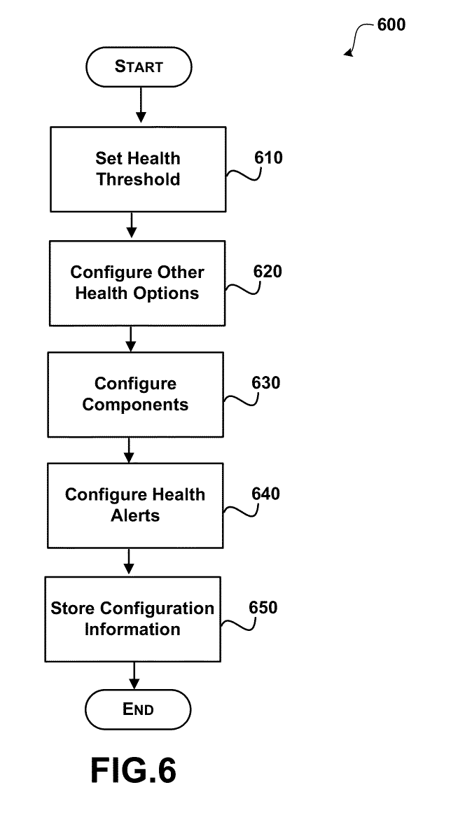

FIGS. 5 and 6 illustrate processes for determining the system level health for an online service. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 5 illustrates a process 500 for determining the system level health for an online service.

After a start operation, the process moves to operation 510, where health scores from different components of the online service are accessed. The health scores may be accessed using one or more methods. For example, a health score from each component may be received from each component, the health scores for the different components may be accessed from a data store (e.g., a table, file . . . ), the health scores may be requested from the components, and the like. According to an embodiment, each component's health score is stored in a table that is accessible by a health manager. The health scores may be received and/or stored either automatically or manually. For example, the health scores may be received at predetermined times (e.g., every two minutes, five minutes, twenty minutes . . . ) or received when requested.

The health score that is associated with each component of the online service may be determined by the component itself or by some other process or component. According to an embodiment, each component of the online service that is used in determining the system level health of the online service determines its own health score. The health scores that are received from the different components may be normalized if the health scores from the different components are not in a same format. For example, if one component uses a numerical value between 1 and 10 to indicate the component health score and another component uses a percentage value to indicate the component's health score, either or both of the different scores may be converted to the same format.

Flowing to operation 520, the overall system health is determined using the health scores that are obtained from the different components of the online service. Many methods may be used to determine the system level health. For example, the overall system level health score for the online service may be determined by computing the average of the health scores that are received from each of the different components. According to an embodiment, the amount an individual component's health score affects the overall system health score of the online service is configurable. For example, user facing components may be set to a higher priority as compared to non-user facing components. In this way, the overall system health score is more affected by components that may affect the user experience more than components that may not directly affect the user experience (See FIG. 6 and related discussion). As discussed above, health scores for different subsystems of the overall service may also be determined. For example, health scores may be determined from the components that are located in different locations and/or health scores may be determined based on some other criteria, such as a particular subset of users of the service.

Transitioning to operation 530, a determination is made as to whether the online service is experiencing a health problem. The determination may be made using different methods and conditions. According to an embodiment, a health problem is determined when the overall system health score drops below a predetermined health threshold (e.g., 99.5%, 99%, 95%, 80% . . . ). According to another embodiment, a health problem for the online service is determined before the overall system health score drops below the predetermined health threshold. For example, a health problem for the online service may be determined when the overall system health score remains between 100% (or some other threshold) and the predetermined health threshold for some period of time. For example, the health problem may be determined when the overall system health score remains at 98% for fifteen minutes or three consecutive determinations of the overall system health score even though the predetermined level for detecting a health problem for the service is set to 95%. According to another embodiment, a health problem is detected when the overall system health score changes quickly (e.g., faster than a predetermined rate of change) between successive determinations of the overall system health score.

Moving to operation 540, one or more health alerts are sent when determined. In some cases, a health alert may be sent both to one or more users at the component level for component(s) experiencing the problem as well as to one or more users at the system level. In other cases, alerts to users at the component level are suppressed such that a user at the system level receives the alert. In this way, the system level administrator may handle the health problem directly without the administrator(s) at the component level also receiving alerts.

The process then flows to an end operation and returns to processing other actions.

FIG. 6 illustrates a process 600 for configuring preferences relating to system level health monitoring of an online service.

After a start operation, the process moves to operation 610, where a health threshold is set. The health threshold is a value that is used in determining when there is a health problem with a component and/or the system. For example, when the health threshold is set to 98% then whenever the overall system health score drops below 98%, a health problem for the system is determined. More than one health threshold may be set. For example, a threshold may be set to indicate a potential health problem (e.g., a caution state) and another threshold may be set to indicate a more serious health problem (e.g., a critical state).

Flowing to operation 620, other health settings may be configured. According to an embodiment, one or more settings may be configured to set when health alerts are sent as well as who is to receive the health alerts. For example, a setting may be configured that indicates to send a health alert when a value for overall system health score is below 100% for five consecutive calculations but remains above the health threshold. Another setting may be configured to specify a rate of change that is used to determine when the overall system health score (or a component's health score) is rapidly changing. This rate of change setting may be used to determine when to send out a health alert. For example, in an attempt to detect a health problem for the online service quicker than waiting for the system level health to drop below the health threshold, an alert may be sent when the overall health score is changing faster than the predetermined rate of change.

Transitioning to operation 630, the components may be configured. For example, a priority value may be assigned to the different components of the online service. The priority value affects the weight that the component's health score has on the overall health score for the online service. For example, when each component has the same priority, the overall system health score is the average value of each of the different health scores. When the priorities are different for the components, then the overall system health score is the weighted average of the health scores from the different components using the assigned priorities as the weighting factors. A user may also configure the component to be included in the overall health score or to be excluded from the overall health score.

Flowing to operation 640, health alerts may be configured. According to an embodiment, a user may determine a format of the health alerts to be sent, what user(s) should receive the health alert, when an alert should be suppressed, and the like. For example, a health alert setting may be configured that specifies to suppress component level alerts when the overall health score falls below the predetermined health threshold. A user may also configure the format of the health alert as well as the information that is included on the health alert. For example, a user may configure to receive a graphical health map along with detailed information relating to any component that is experiencing a health problem.

Transitioning to operation 650, the configuration information is stored. The configuration information may be stored in one more locations. For example, the configuration information may be stored in a memory, a data store of the online service and/or in an external data store from the online service.

The process then flows to an end operation and returns to processing other actions.

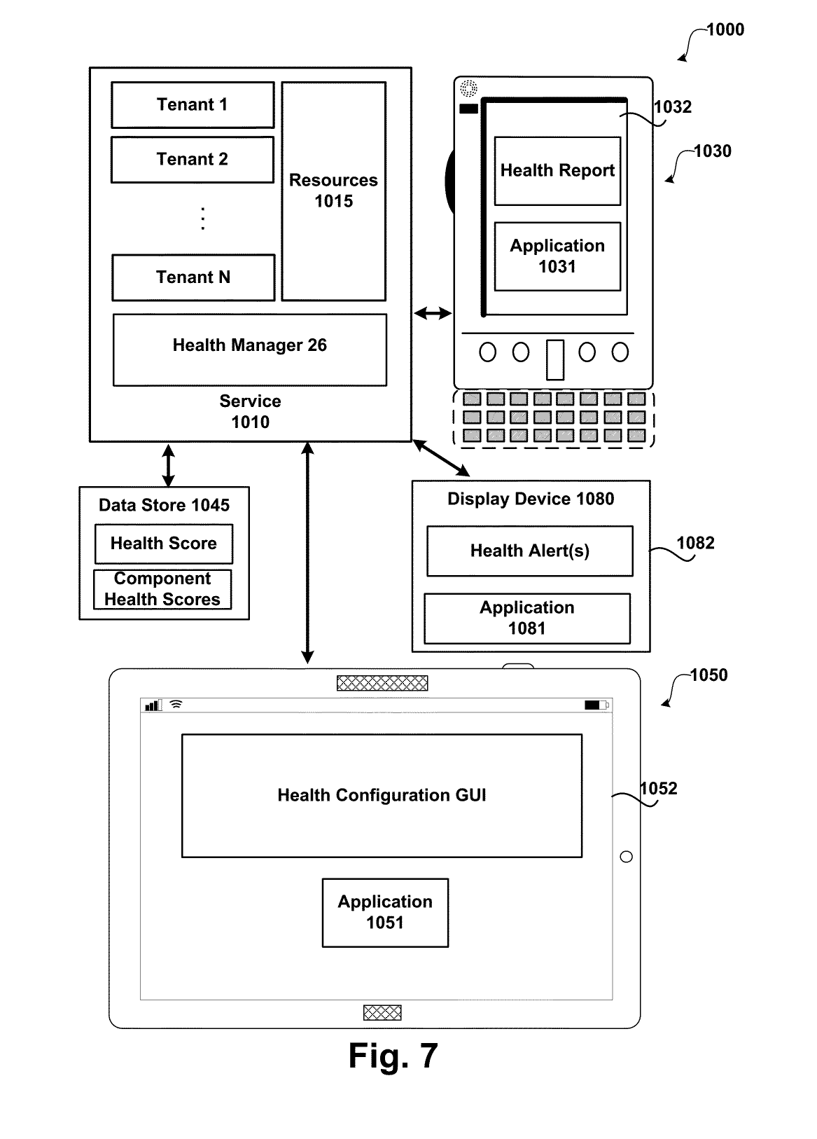

FIG. 7 illustrates an exemplary online system that includes system level health monitoring. As illustrated, system 1000 includes service 1010, data store 1045, and touch screen input device 1050 (e.g. a slate), smart phone 1030 and display device 1080.

Service 1010 is a cloud based and/or enterprise based service that may be configured to provide services, such as messaging services and productivity services (e.g. spreadsheets, documents, presentations, charts, messages, and the like). The service may be interacted with using different types of input/output. For example, a user may use speech input, touch input, hardware based input, and the like. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, and inductive sensors.

According to an embodiment, smart phone 1030, touch screen input device 1050, and device 1080 each include an application (1031, 1051, 1081).

As illustrated, touch screen input device 1050, smart phone 1030, and display device 1080 shows exemplary displays 1052/1032/1082 showing the use of an application and a display relating to the health of a system and components. Data may be stored on a device (e.g. smart phone 1030, slate 1050 and/or at some other location (e.g. network data store 1045). Data store 1045, or some other store, may be used to health scores, health configuration information, as well as other data. The applications used by the devices may be client based applications, server based applications, and cloud based applications and/or some combination. According to an embodiment, display device 1080 is a device such as a MICROSOFT XBOX coupled to a display.

Health manager 26 is configured to perform operations relating to system level health monitoring as described herein. While health manager 26 is shown within service 1010, the functionality of the health manager 26 may be included in other locations (e.g. on smart phone 1030 and/or slate device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

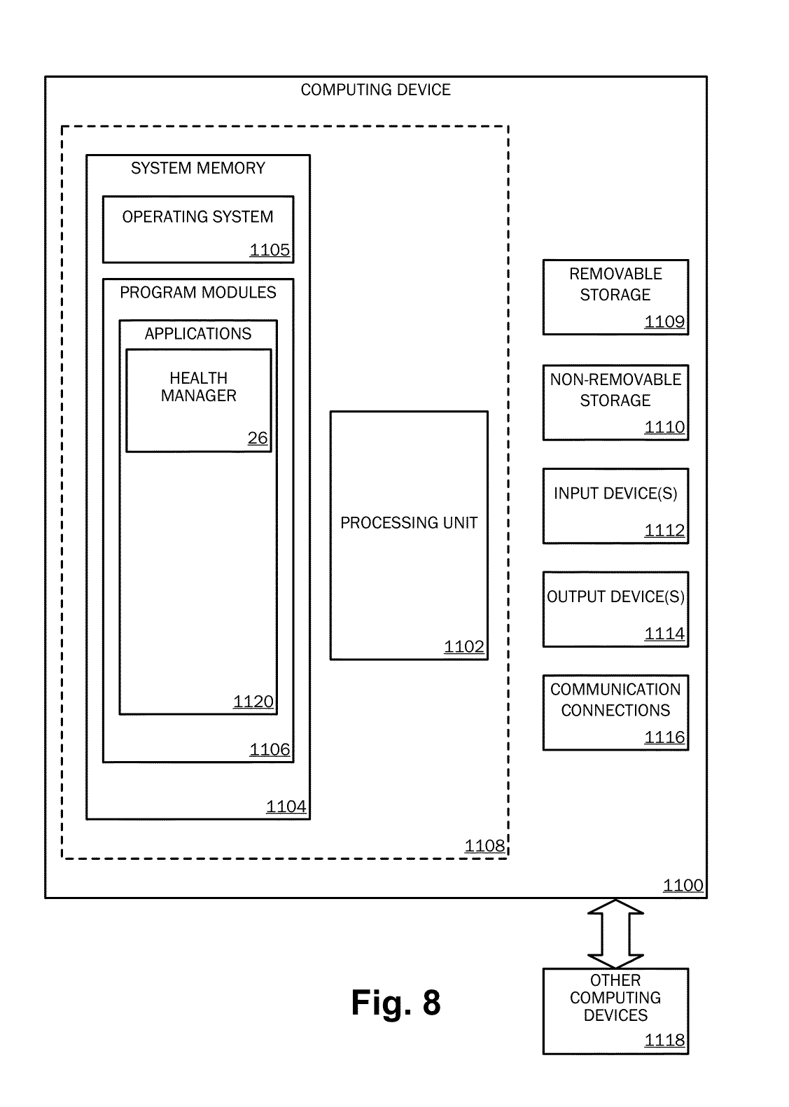

FIGS. 8-10 and the associated descriptions provide a discussion of a variety of operating environments in which embodiments of the invention may be practiced. However, the devices and systems illustrated and discussed with respect to FIGS. 8-10 are for purposes of example and illustration and are not limiting of a vast number of computing device configurations that may be utilized for practicing embodiments of the invention, described herein.

FIG. 8 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the health manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 8 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 8 by a removable storage device 1109 and a non-removable storage device 1110.

As stated above, a number of program modules and data files may be stored in the system memory 1104. While executing on the processing unit 1102, the program modules 1106 (e.g., the health manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the health manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

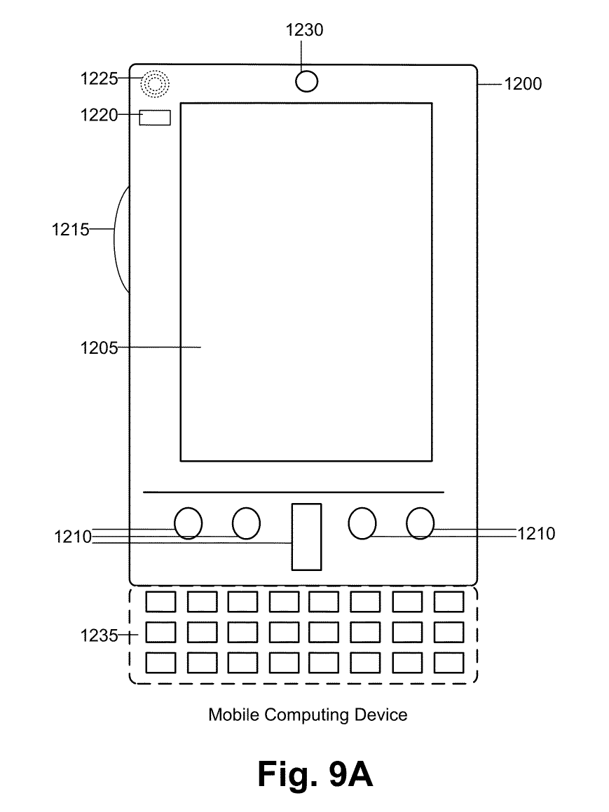

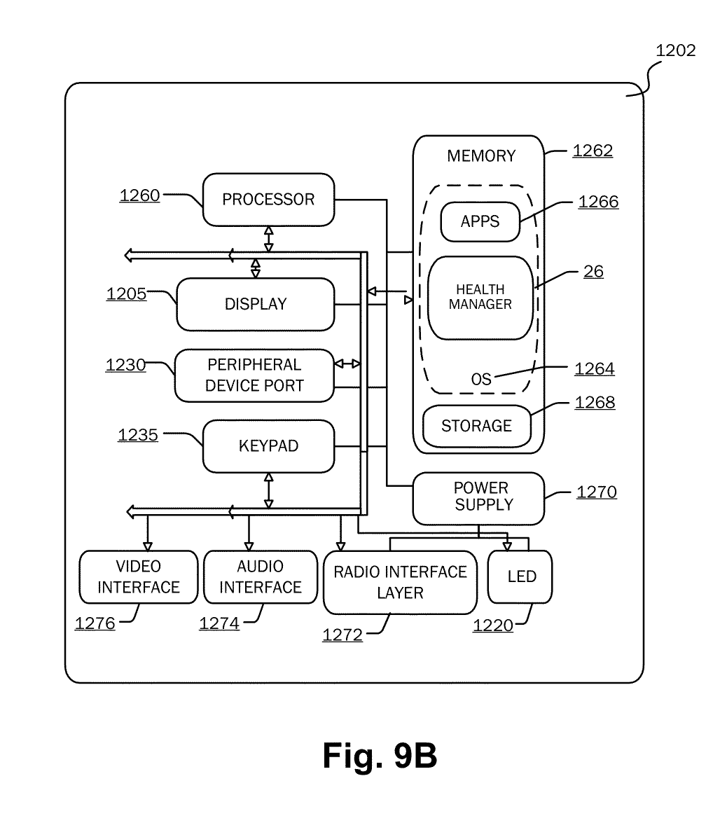

FIGS. 9A and 9B illustrate a mobile computing device 1200, for example, a mobile telephone, a smart phone, a tablet personal computer, a laptop computer, and the like, with which embodiments of the invention may be practiced. With reference to FIG. 9A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the health manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 9B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

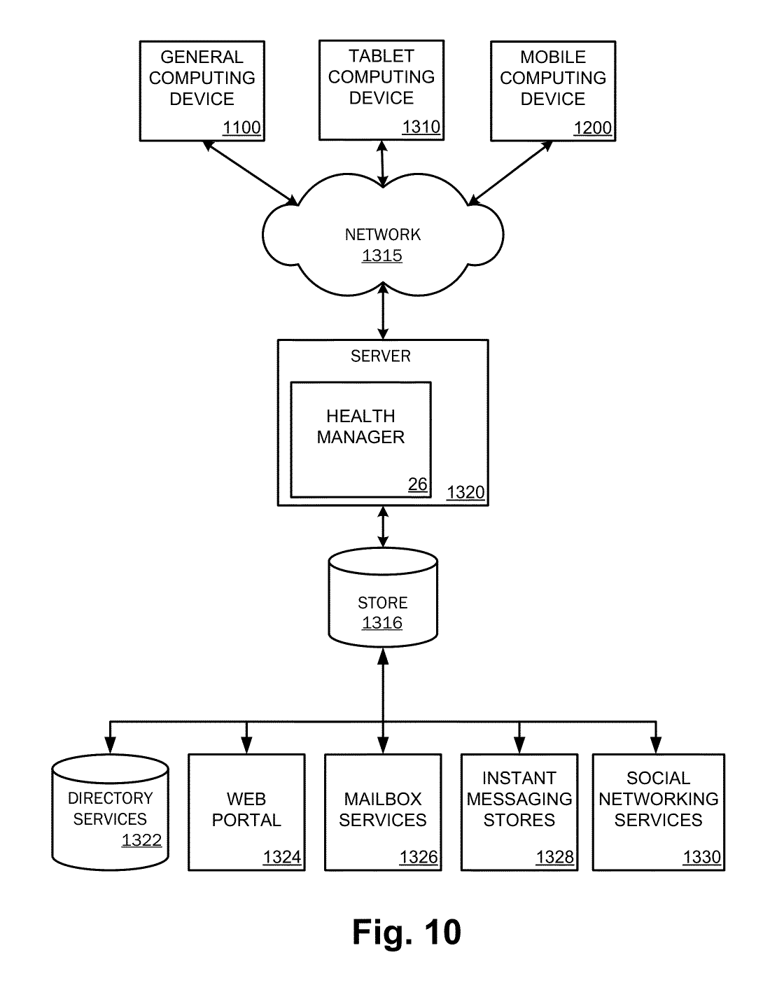

FIG. 10 illustrates an embodiment of an architecture of an exemplary system, as described above. Content developed, interacted with, or edited in association with the health manager 26 may be stored in different communication channels or other storage types. For example, various documents may be stored using a directory service 1322, a web portal 1324, a mailbox service 1326, an instant messaging store 1328, or a social networking site 1330. The health manager 26 may use any of these types of systems or the like for enabling data utilization, as described herein. A server 1320 may provide the health manager 26 to clients. As one example, the server 1320 may be a web server providing the health manager 26 over the web. The server 1320 may provide the health manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for system level health monitoring, comprising:
accessing health scores from different components of an online service that each indicate a current health of one of the different components;
calculating an overall system health of the online service using the health scores obtained from the different components of the online service;
determining when the overall system health indicates a health problem for the online service; and
sending an alert in response to determining the health problem.

2. The method of claim 1, wherein calculating the overall system health of the online service using the health scores obtained from the different components of the online service comprises determining an average score of the health scores obtained from the different components.

3. The method of claim 2, wherein determining the average score from the health scores obtained from the different components comprises adjusting the health scores based on an assigned priority that is associated with each of the different components.

4. The method of claim 1, wherein determining when the overall system health indicates the health problem for the online service comprises determining when a value of an overall system health score drops below a predetermined health threshold.

5. The method of claim 4, wherein determining when the overall system health indicates the health problem for the online service comprises determining when the value of the overall system health score stays above the predetermined health threshold but remains below a second threshold for a predetermined period of time.

6. The method of claim 4, wherein determining when the overall system health indicates the health problem for the online service comprises determining when the value of the overall system health score changes faster than a predetermined rate of change from a previous determination of the overall system health score.

7. The method of claim 1, further comprising suppressing a component health alert when the health problem for the online service is determined.

8. The method of claim 1, further comprising displaying a Graphical User Interface (GUI) that shows a health map of the components and the online service, wherein graphical representations of the components and the online service are colored to indicate a current level of health.

9. The method of claim 1, further comprising displaying a Graphical User Interface (GUI) that is used to prioritize the components.

10. A computer-readable storage medium storing computer-executable instructions for system level health monitoring of an online service, comprising:
accessing health scores from different components of an online service that each indicate a current health of one of the different components;
calculating an overall system health score of the online service by determining an average health score using the health scores obtained from the different components of the online service;
determining when the overall system health score indicates a health problem for the online service; and
sending an alert in response to determining the health problem.

11. The computer-readable storage medium of claim 10, wherein determining the average health score comprises adjusting a value of each of the health scores based on an assigned priority that is associated with each of the different components.

12. The computer-readable storage medium of claim 10, wherein determining when the overall system health score indicates the health problem for the online service comprises determining when a value of the overall system health score drops below a predetermined health threshold.

13. The computer-readable storage medium of claim 10, wherein determining when the overall system health score indicates the health problem for the online service comprises determining when the value of the overall system health score stays above the predetermined health threshold but remains below a second threshold for successive determinations of the overall health score.

14. The computer-readable storage medium of claim 10, wherein determining when the overall system health indicates the health problem for the online service comprises determining when the value of the overall system health score changes faster than a predetermined rate of change from a previous determination of the overall system health score.

15. The computer-readable storage medium of claim 10, further comprising suppressing component health alerts when the health problem for the online service is determined and sending the alert to a system level administrator in response to determining the health problem.

16. The computer-readable storage medium of claim 10, wherein sending the alert comprises creating a graphical health map of the components and the online service, wherein graphical representations of the components and the online service are colored in the graphical health map to indicate a current level of health.

17. The computer-readable storage medium of claim 10, further comprising displaying a Graphical User Interface (GUI) that is used to: prioritize the components; set the health threshold; configure when to send the alert; and when to suppress alerts.

18. A system for system level health monitoring of an online service, comprising:
a processor and memory;
an operating environment executing using the processor; and
a health manager that is configured to perform actions comprising:
accessing health scores from different components of an online service that each indicate a current health of one of the different components;
calculating an overall system health score of the online service by determining an average health score using the health scores obtained from the different components of the online service;
determining when the overall system health score indicates the health problem by performing operations, including:
determining when a value of the overall system health score is below a health threshold;
determining when the value of the overall system health score is greater than the health threshold but less than a second threshold; and
sending an alert in response to determining the health problem.

19. The system of claim 18, wherein determining the average health score comprises adjusting a value of each of the health scores based on an assigned priority that is associated with each of the different components.

20. The system of claim 18, wherein sending the alert comprises creating a graphical health map of the components and the online service, wherein graphical representations of the components and the online service are colored in the graphical health map to indicate a current level of health.
